(19) United States
(12) Patent Application Publication
(10) Pub. No.: US 2009/0114103 A1
(43) Pub. Date: May 7, 2009

(54) Collecting Device

(75) Inventor: Mark O'Shea, Dublin (IE)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(73) Assignee: LIFESTYLE FOODS LIMITED, Dublin (IE)

(21) Appl. No.: 12/280,554

(22) PCT Filed: May 8, 2006
(86) PCT No.: PCT/IE06/00050

§ 371 Date: Oct. 14, 2008

(30) Foreign Application Priority Data
May 10, 2005 (IE) S2005/0296

(51) Int. Cl. A21B 1/48

(52) U.S. Cl. 99/443 C; 99/444; 29/428

(57) ABSTRACT

A collecting device (1) for catching crumbs which fall through constructional gaps in the conveyor belt (4) of an oven (2) during baking. The device (1) has an elongated upper plate (10) having a plurality of through perforations (10a) which is mounted beneath the top flight (4a) of the conveyor and extends across the width of the belt (4). A directing panel (7) is attached to each longitudinal edge (10b) of the upper plate (10) perpendicular to the plate (10). The crumbs which fall through the conveyor belt (4) are first received in the perforations (10a) in the upper plate (10) and then directed by the panels (7) into a removable container (5) beneath the lower edges (7b) of the panels. In an oven (2) which has a metal sheet (20) installed beneath the top flight (4a) of the conveyor belt (4) parallel to the belt, the upper plate (10) is installed by firstly excising a similarly sized portion of material from the metal sheet (10) and then substituting the excised portion with the upper plate (10).

### TECHNICAL FIELD

The present invention relates to a collecting device and in particular to a collecting device for receiving particles of material.

### BACKGROUND ART

In the baking industry, conveyor ovens are often used in a continuous process for making bread, pastries etc. in a production line environment. Prepared and shaped dough portions are placed onto a metallic conveyor belt at an entry side of a baking chamber of such an oven and baked as the conveyor belt travels through the baking chamber towards an exit side thereof. In some such ovens, a metal sheet is provided by the oven structure and is mounted beneath an upper length of the conveyor belt. Width and length of the metal sheet are approximately the same as those of the upper length of the conveyor belt. Typically, dough portions are subjected to proving in a proving chamber prior to baking. The dough portions are placed onto peel boards dusted with flour, typically semolina flour, in order to aid removal of the dough portions from the peel boards. After removal of the dough portions from the peel boards some flour usually remains stuck to the dough portions. However, during baking, some flour inevitably detaches from the dough portions and falls through gaps in the conveyor belt onto the metal sheet. The distance between the underside of the conveyor belt and the metal sheet is very small making it difficult to access the space between the underside of the belt and the metal sheet and flour particles remain trapped in the space.

The present invention seeks to alleviate the above disadvantages.

### SUMMARY OF THE INVENTION

Accordingly, the invention provides a collecting device for mounting beneath a top flight of a conveyor belt for receiving waste particles which fall through gaps in the top flight of the conveyor belt, the collecting device comprising an elongate upper plate having a plurality of through apertures, said plate being mountable beneath the top flight of the conveyor so as to extend across the width of the belt, the device further comprising a pair of panels spaced apart in the direction of travel of the belt, each panel being mountable in the region of one of two longitudinal edges of the upper plate so as to project proud in relation to the upper plate and so that particles or material falling from product as it is transferred onto or travels on the conveyor belt are received in the apertures of the upper plate and directed by the panels into a removable container located beneath lower free edges of the panels.

The invention also provides a method of installing a collecting device as described above in a conveyor oven having a metal sheet installed beneath a top flight of an oven conveyor belt and having plane dimensions matching those of the top flight, comprising the steps of:

excising a transversely extending portion from the metal sheet and substituting it with the upper plate of the collecting device;

affixing the longitudinal edges of the upper plate to those edges of the metal sheet which surround a gap formed by excision of the portion from the metal sheet; and

affixing the panels to the underside of the metal sheet so that an upper edge of each panel extends along one of the longitudinal edges of the upper plate.

### BRIEF DESCRIPTION OF THE DRAWINGS

In the drawings:

FIG. 1 is a schematic side elevation of a conveyor oven with a collecting device of the invention installed beneath a conveyor belt of the oven;

FIG. 2 is plan view of the conveyor oven of FIG. 1;

FIG. 3 is an enlarged portion of FIG. 1 showing the collecting device;

FIG. 4 is an enlarged portion of FIG. 2 showing the collecting device;

FIG. 5 is a schematic side elevation of the collecting device of the invention; and

FIG. 6 is a plan view of a perforated plate of the collecting device of the invention;

FIG. 7 is a perspective view of panels of the collecting device.

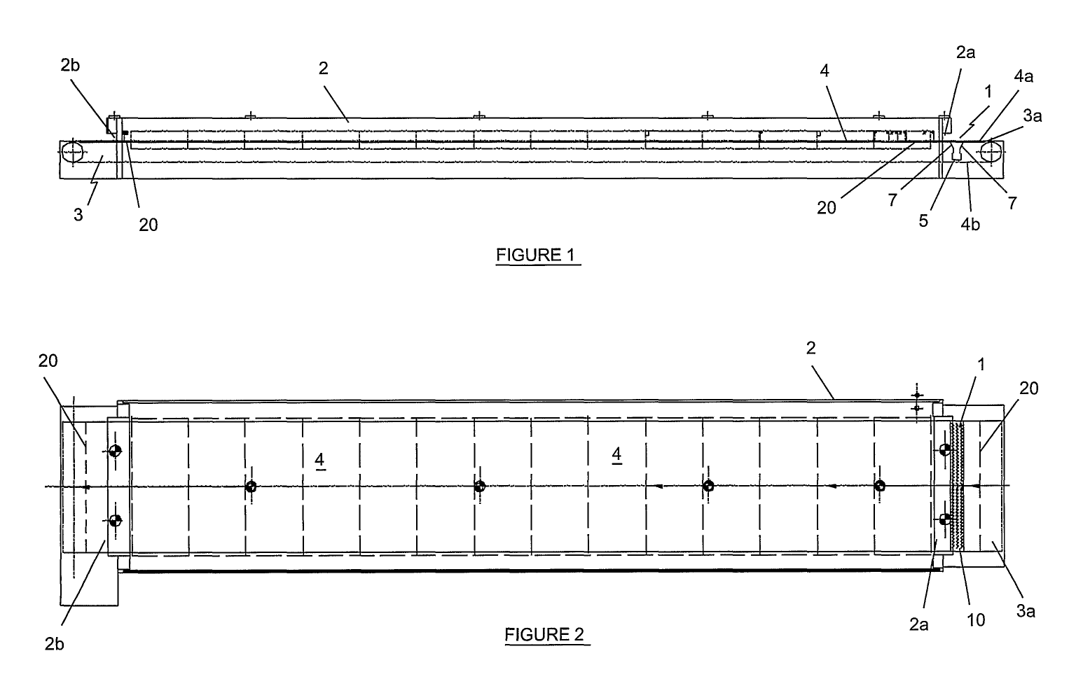

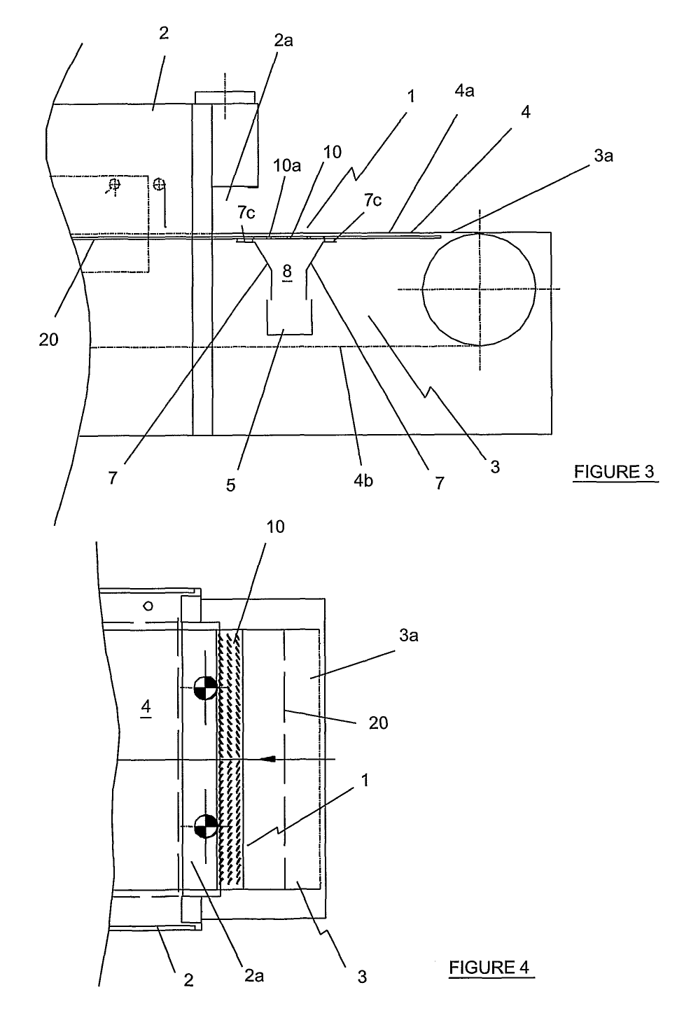

### DETAILED DESCRIPTION

The present invention will now hereinafter be described with reference to the accompanying drawings which show, by way of example only, one embodiment of a collecting device of the invention.

As discussed in detail below, the invention provides a collecting device for mounting beneath a top flight of a conveyor belt for receiving waste particles which fall through gaps in the top flight of the conveyor belt, the collecting device comprising an elongate upper plate having a plurality of through apertures, said plate being mountable beneath the top flight of the conveyor so as to extend across the width of the belt, the device further comprising a pair of panels spaced apart in the direction of travel of the belt, each panel being mountable in the region of one of two longitudinal edges of the upper plate so as to project proud in relation to the upper plate and so that particles or material falling from product as it is transferred onto or travels on the conveyor belt are received in the apertures of the upper plate and directed by the panels into a removable container located beneath lower free edges of the panels.

The collecting device is most suitable for use in a conveyor oven, the structure of which provides a metal sheet installed beneath a top flight of an oven conveyor belt and having plane dimensions approximately matching those of the top flight, the collecting device being installed by excising a transversely extending portion from the metal sheet and substituting it with the upper plate of the collecting device. Preferably, the upper plate is affixed by the longitudinal edges to those edges of the metal sheet which surround a gap formed by excision of the portion from the metal sheet. Ideally, the longitudinal edges of the plate are welded to said edges of the metal sheet.

Preferably, the panels are affixed to the underside of the metal sheet so that an upper edge of each panel extends along one of the longitudinal edges of the upper plate.

Ideally, the panels are connected to the underside of the metal sheet. In a most preferred arrangement, the panels are constructed of metal and fixed to the metal sheet by suitable means, such as welding.

Conveniently, a lip is provided along the upper edge of each panel. The panel is affixed to the metal sheet by the lip and preferably, by welding the lip to the underside of the metal sheet.

The device is further suitable for collecting particles of dusting flour which fall through gaps in said conveyor belt from dough portions received on an in-feed portion of the oven conveyor belt before the dough portions enter a baking chamber of the oven. It is also suitable for catching particles which fall from the product as it is introduced into the oven from an external conveyor and transferred onto the conveyor within the oven.

Preferably, the collecting device is mountable intermediate the in-feed portion of a conveyor and an entry into the baking chamber of the oven. Additionally, a collecting device is mountable at an exit side of said baking chamber.

Ideally, each panel comprises a first portion, which in use is proximal the upper edge of the panel and a second portion which in use in proximal the lower edge of the panel wherein the first portions of both the panels converge towards the lower edges and the second portions are substantially parallel.

Preferably, the apertures of the upper plate comprise slots having a diagonal orientation relative to the direction of travel of the conveyor belt. Such a configuration and orientation of the apertures has been found useful in preventing premature wear of the conveyor belt underneath which the collecting device is installed during transfer of flour particles from the conveyor belt into the collecting device.

The invention further provides a conveyor belt of an oven having a top flight, a bottom flight and a metal sheet installed beneath the top flight, the metal sheet having substantially the same plane dimensions as those of the top flight and the metal sheet having a collecting device as described herein integrated therewith.

The invention also provides a method of installing a collecting device as described above in a conveyor oven having a metal sheet installed beneath a top flight of an oven conveyor belt and having plane dimensions matching those of the top flight, comprising the steps of:

excising a transversely extending portion from the metal sheet and substituting it with the upper plate of the collecting device;

affixing the longitudinal edges of the upper plate to those edges of the metal sheet which surround a gap formed by excision of the portion from the metal sheet; and

affixing the panels to the underside of the metal sheet so that an upper edge of each panel extends along one of the longitudinal edges of the upper plate.

Referring to the drawings, the collecting device is indicated generally by reference numeral 1. The collecting device 1 is particularly suitable for use in a conveyor oven for collecting flour particles, crumbs or other particles of material falling through gaps in a conveyor belt of such an oven from the outer surface of a top flight of the conveyor belt. More specifically, the collecting device is useful in an oven in which the structure of the oven provides a metal sheet installed beneath the top flight of the conveyor belt.

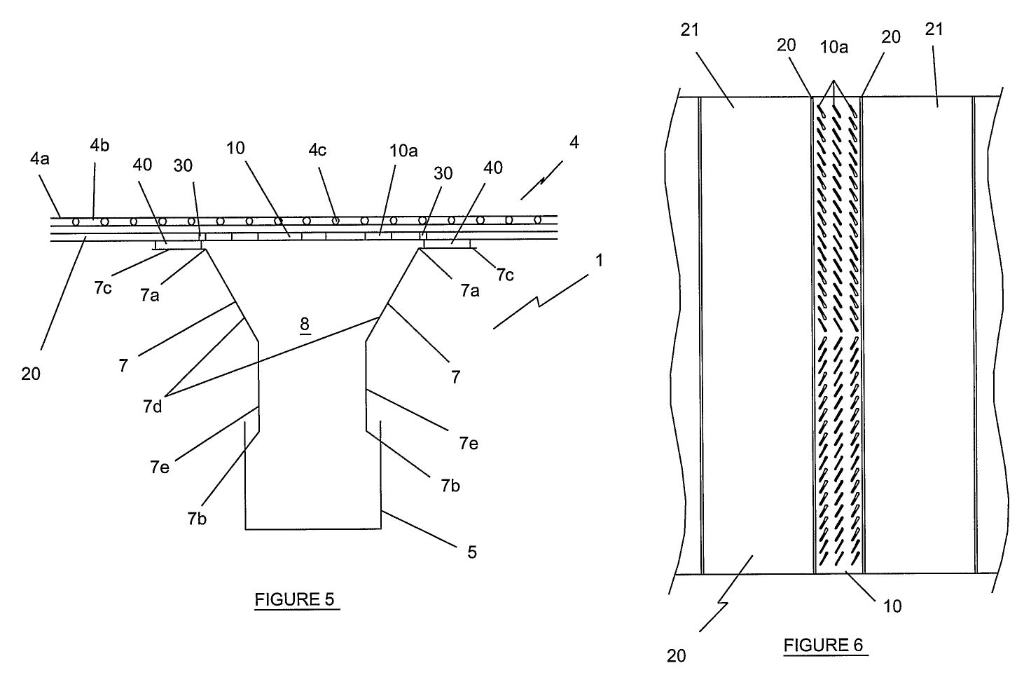

The collecting device 1 is described in use in a conveyor oven 2. The conveyor oven 2 comprises a conveyor extending along a baking chamber of the oven 2 and having a conveyor belt 4. The conveyor belt 4 has a top flight 4a and a bottom flight 4b. The conveyor belt is comprised of a plurality of metal segments 4b (see FIG. 5) pivotally connected to each other via hinges 4c. A metal sheet 20 is installed beneath the top flight 4a of the conveyor belt 4 and has approximately the same width and length as the top flight 4a. The metal sheet 20 is comprised of a plurality of welded together smaller metal plates (not shown).

Such a conveyor oven is usually integrated into a bakery production line.

Portions of shaped dough are initially received on a porch section 3a of the conveyor 3 from a delivery conveyor (not shown). The belt 4 then conveys these shaped portions of dough into the baking chamber of the conveyor oven 2 through an in-feed port 2a. The dough portions are baked as they are conveyed through the baking chamber and exit the baking chamber through an out-feed port 2b of the oven 2.

Portions of dough are usually dusted with flour, commonly with semolina flour, in order to reduce sticking of the dough portions to various surfaces during shaping and transfer of the dough portions between various processing steps. For example, before transfer to the oven, dough portions are placed onto so called peel boards and are left in a proving chamber for a specified time period, normally several hours. The peel boards are sprinkled with semolina flour in order to aid removal of the of the dough portions from the peel boards. After removal of the dough portions from the peel boards, some of the semolina flour remains stuck to the dough portions.

As the shaped dough portions are transferred onto the porch section 3a of the conveyor 3, some of the semolina flour inevitably detaches from the dough portions and passes through gaps between the metallic segments 4b and the hinges 4c of the conveyor belt 4. During the transfer of the dough portions onto the conveyor 4, the dough portions are subjected to minor vibrations which disturb the particles of flour stuck to the dough portions.

The collecting device 1 is installed intermediate the porch section 3a and the in-feed port 2a so as to collect flour particles falling through gaps in the conveyor belt 4 before the dough portions enter the baking chamber. Most of the flour particles which can potentially dislodge from the dough portions during handling do so during the transfer of the dough portions onto the porch section 3a of the conveyor 3 when the flour particles are disturbed. Little or no flour detaches from the dough portions once they enter the baking chamber of the oven 2 because due to baking conditions crust is formed on the dough portions almost immediately after the dough portions enter the chamber 2.

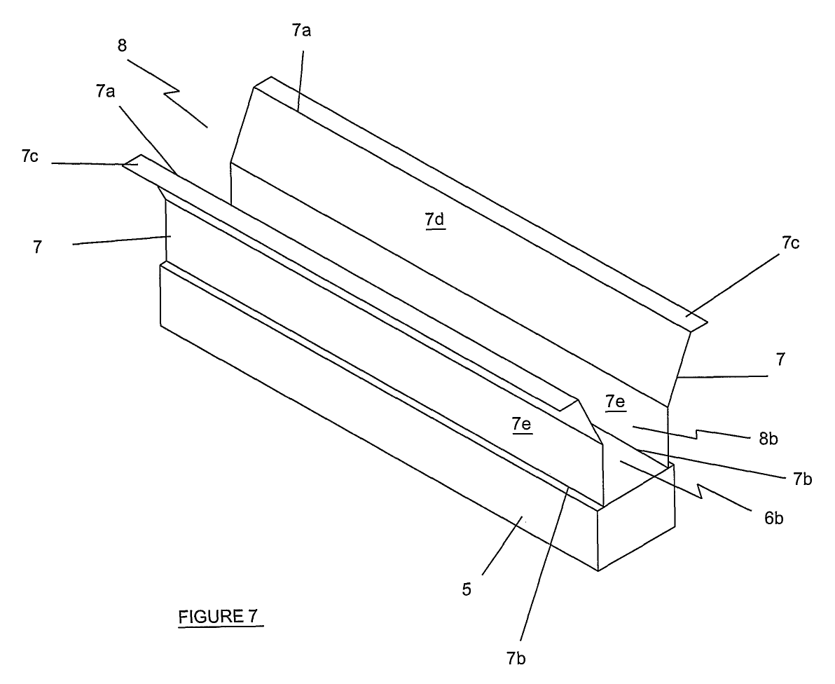

Referring to FIGS. 5 and 6, the collecting device 1 comprises an elongate upper plate 10 having a plurality of through perforations 10a. The plate 10 is located beneath the top flight 4a of the conveyor belt 4, substantially perpendicular to the direction of travel of the belt. The plate 10 is installed by cutting out an elongate portion from the metal sheet 20 which extends perpendicular to the direction of travel of the conveyor belt 4, the portion having the same or approximately the same width and length as the upper plate 10 so as to form a gap across the metal sheet 20. The removed portion is substituted by the upper plate 10 of the collecting device 1. The upper plate 10 is affixed to edges of the metal sheet 20 which surround the gap formed by removing the portion of material from the metal sheet 20. The plate 10 is preferably affixed by welding longitudinal edges 10b of the upper plate 10 to the edges defining the gap and forming weld seams 30. It will be appreciated that other suitable means may be used to form and/or to affix the upper plate 10 to the metal sheet 20.

The collecting device 1 further comprises a pair of metal panels 7 which are spaced apart along the path of travel of the conveyor belt 4 and mounted at its upper edges to project downwards in relation to the upper plate 10. Each panel 7 has an upper edge 7a and a lower edge 7b. A lip 7c is provided along the upper edge 7a. A space 8 is defined between the panels 7. The panels have first portions 7d proximal the upper edges 7a and second portions proximal the lower edges 7b. The first portions 7d taper towards the lower edges 7b and the second portions 7e are substantially parallel. The panels 7 are affixed to the underside of the metal sheet 20 by welding the lips 7c thereto and forming weld joints 40. Of course other suitable ways are possible to secure the panels 7 in place, and indeed, the panels may be affixed to or integral with the upper plate 10.

The panels 7 and the upper plate 10 are sized to extend across the entire width of the conveyor belt 4.

A catch pan 5 is placed beneath the lower edges 7b of the panels 7. The catch pan 5 is removable from one of the longitudinal sides of the conveyor oven 2. Typically, during a production run the catch pan 5 is removed every six to eight hours.

As the dough portions are conveyed on the belt 4 from the porch section 3a to the in-feed port 2a of the oven 2 they pass above the upper plate 10. Those semolina flour particles which have been disturbed by the transfer of the dough portions onto the porch section 3a and which dislodge from the dough portions will pass through the gaps between the metallic segments 4b and the hinges 4c of the conveyor belt 4 on the porch section 3a. During the travel of the particles through the gaps in the belt 4, the belt 4 travels on towards the upper plate 10 so that when the flour particles exit the gaps at the underside of the conveyor belt 4, they are received firstly in the apertures 10a of the plate 10 and then in the space 8 between the panels 7. The upper tapered portions 7d of the panels 7 direct the flour particles towards the lower edges 7b at which the flour particles exit the space 8 and fall into the catch pan 5. The panels 7 direct the flour particles straight into the catch pan 5 thus preventing the flour particles from getting trapped in various places in the interior of the oven, which are often difficult to reach.

The perforations 10a can be of any suitable configuration, however perforations in a form of slots having diagonal orientation in relation to the longitudinal edges 10b have been found particularly useful in preventing increased wear of the conveyor belt 4 during travel of flour particles from the conveyor belt 4 to the upper plate 10.

The flour particles falling from the shaped dough portions are collected by the collecting device 1 before the shaped dough portions enter the baking chamber of the oven 2. This has an advantage that the flour particles will not get baked and/or burnt in the oven 2 and will not contaminate the environment in the oven. In this way, the occurrence of unsightly black-spots or carbonised, contaminating semolina specks on the final bread product is avoided. In addition, the risk of spot fire occurring in the oven is reduced.

It is thought that the present invention and its advantages will be understood from the foregoing description and it will be apparent that various changes may be made thereto without departing from the scope of the invention, the forms hereinbefore described being merely preferred or exemplary embodiments thereof.

1. The collecting device for mounting beneath a top flight of a conveyor belt for receiving waste particles which fall through gaps in the top flight of the conveyor belt, the collecting device comprising an elongate upper plate having a plurality of through apertures, the plate being mountable beneath the top flight of the conveyor so as to extend across the width of the belt, the device further comprising a pair of panels spaced apart in the direction of travel of the belt, each panel being mountable in the region of one of two longitudinal edges of the upper plate so as to project proud in relation to the upper plate and so that particles or material falling from product as it is transferred onto or travels on the conveyor belt are received in the apertures of the upper plate and directed by the panels into a removable container located beneath lower free edges of the panels.

2. The collecting device as claimed in claim 1, the collecting device being installable in a conveyor oven having a metal sheet beneath a top flight of an oven conveyor belt having plane dimensions matching those of the top flight from which metal sheet a transversely extending portion has been excised, the upper plate of the collecting device being positionable in place of the excised portion.

3. The collecting device as claimed in claim 2, in which the upper plate is connectable by the longitudinal edges to those edges of the metal sheet which surround a gap formed by excision of the portion from the metal sheet.

4. The collecting device as claimed in claim 3, in which the panels are connectable to the underside of the metal sheet so that an upper edge of each panel extends along one of the longitudinal edges of the upper plate.

5. The collecting device as claimed in claim 4, in which a lip is provided along the upper edge of each panel and the panel is connectable to the metal sheet by the lip.

6. The collecting device as claimed in claim 2, the collecting device being mountable intermediate an in-feed portion of the conveyor and an entry into a baking chamber of the oven.

7. The collecting device as claimed in The, in which each panel comprises a first portion, which in use is located proximal the upper edge of the panel and a second portion which in use is located proximal the lower edge of the panel wherein the first portions of both the panels converge towards the lower edges and the second portions are substantially parallel.

8. The collecting device as claimed in claim 1, in which the apertures of the upper plate comprises slots having a diagonal orientation relative to the direction of travel of the conveyor belt when the plate is installed in the oven.

9. A method of installing a collecting device of claim 1 in a conveyor oven having a metal sheet installed beneath a top flight of an oven conveyor belt and having plane dimensions matching those of the top flight, comprising the steps of:
excising a transversely extending portion from the metal sheet and substituting it with the upper plate of the collecting device;
affixing the longitudinal edges of the upper plate to those edges of the metal sheet which surround a gap formed by excision of the portion from the metal sheet; and
affixing the panels to the underside of the metal sheet so that an upper edge of each panel extends along one of the longitudinal edges of the upper plate.

10. A conveyor belt of a conveyor oven having a metal sheet installed beneath a top flight of the conveyor belt, the metal sheet having plane dimensions matching those of the top flight, the conveyor belt being fitted with the collecting device of claim 1.
